(19) United States
(12) Patent Application Publication
(10) Pub. No.: US 2010/0219640 A1
(43) Pub. Date: Sep. 2, 2010

(54) Electrical Power Generation via the Movement of a Fluid Body

(76) Inventor: Fernando Gracia Lopez, Garza Garcia (MX)

Correspondence Address: FISH & RICHARDSON P.C., P.O. BOX 1022, MINNEAPOLIS, MN, 55440-1022, US

(21) Appl. No.: 12/539,269

(22) Filed: Aug. 11, 2009

Related U.S. Application Data
(60) Provisional application No. 61/188,573, filed on Aug. 11, 2008.

(51) Int. Cl. F03B 13/18; F04B 17/00

(52) U.S. Cl. 290/53; 417/330; 417/331; 417/53

(57) ABSTRACT

Systems, processes, and techniques for harnessing the dynamic energy of a fluid body may be used to generate electric power. In particular implementations, harnessing the dynamic energy of a fluid body may include the ability to follow movements of a fluid body and pressurize a volume of fluid due to following the movement. The pressurized volume of fluid may be used, at least in part, to drive an electrical power generator.

### RELATED APPLICATIONS

This application claims the benefit under 35 U.S.C. §119(e) of U.S. Provisional Patent Application No. 61/188,573, entitled “Electrical Power Generation via the Movement of a Fluid Body” and filed on Aug. 11, 2008, the entire contents of which are incorporated herein by reference.

### TECHNICAL FIELD

The present disclosure relates to harnessing dynamic energy of a fluid body and, more particularly, to systems, processes, and techniques for converting dynamic action of a fluid body into a fluid pressurization action that may be used to generate electrical power.

### BACKGROUND

The world's population has steadily continued to demand more energy for social and economic development. Moreover, the world's population has continued to increase. Thus, the need for energy has continued to expand.

Many traditional techniques for producing energy (e.g., combusting coal and natural gas) have become increasingly expensive with increased energy demand. Also, these techniques, as well as alternative techniques (e.g., nuclear), have numerous environmental drawbacks. Other traditional techniques (e.g., hydroelectric and wind) have not been able to keep pace with demand.

### SUMMARY

This disclosure describes systems, processes, and technique for converting the dynamic action of fluid body into fluid pressurization that may be used for generating electrical power. In one general aspect, a system for utilizing movements of a fluid body to pressurize a pumping fluid for generating electrical power may include a pumping station positioned offshore. The pumping station may include a housing having a reservoir containing a volume of pumping fluid and at least one pumping mechanism. In particular implementations, the pumping station may include a plurality of radially disposed pumping mechanisms. The pumping mechanism(s) may include a moveable member and a fluid pump. The moveable member may extend at least partially from the housing and be adapted to follow movements of the fluid body. The fluid pump may be coupled to the moveable member and adapted to pressurize a pumping fluid in response to motion of the moveable member. The fluid pump may include a multi-chambered cylinder, a shaft extending through the multi-chambered cylinder and driven by the moveable member, and a plurality of pistons attached to the shaft. Each piston may be disposed in a separate chamber of the multi-chambered cylinder, and the pistons may be adapted to pressurize a pumping fluid in response to motion of the moveable member.

In certain implementations, the moveable member may be coupled to the shaft by a power conversion mechanism. The power conversion mechanism may, for example, include a gear rotatably coupled to the moving member and driven thereby, and a linkage (e.g., a cam linkage) operably disposed between the gear and the shaft of the fluid pump to drive the shaft. The power conversion mechanism may be adapted to cause the pistons in the multi-chambered cylinder to cycle at least one time for a displacement of the moveable member of at least a defined distance in a first direction and to cycle at least one time for a displacement of the moveable member at least the defined distance in a second direction.

The moveable member may have various configurations. For example, the moveable member may include an elongated member that extends from the housing and a buoyant member pivotably coupled to the elongated member proximate an end of the elongated member distal from the housing and adapted to follow movements of the fluid body.

In certain implementations, at least a portion of the pumping mechanism is at least partially submerged in the pumping fluid contained within the housing.

In particular implementations, the piston is adapted to allow the pumping fluid to pass from one side of the piston to the other. For instance, the piston may be adapted to allow the pumping fluid to pass from one side of the piston to the other when the piston moves in a first direction but not allow the pumping fluid to pass from one side of the piston to the other when the piston moves in a second direction.

A power generation station may be coupled to the pumping station and driven by the pressurized pumping fluid to generate electrical power. The power generation station may include a fluid-mechanical power converter and a power generator. The power converter may be positioned on a shore of the fluid body and coupled to a first conduit system that conveys the pressurized pumping fluid from the pumping station and a second conduit system that conveys the pumping fluid back to the pumping station. The power generator may be coupled to and driven by the power converter. In certain implementations, the system may include a plurality of pumping stations that drive the power generation station with pressurized pumping fluid.

In another general aspect, a process for utilizing movements of a fluid body to pressurize a pumping fluid for generating electrical power may include actuating a moveable member extending from a housing located offshore in response to movements of a fluid body, driving a shaft of a multi-chambered fluid pump in the housing based on actuation of the movable member, and pressurizing pumping fluid from a reservoir in the housing with pistons located in the chambers of the fluid pump and coupled to the shaft. At least a portion of the moveable member and the shaft may be submerged in the pumping fluid contained in the housing.

The process may also include conveying the pressurized pumping fluid to a remote location, converting energy of the pressurized pumping fluid into mechanical power at the remote location, generating electrical power with the mechanical power, and conveying the pumping fluid back to the housing.

In certain implementations, the process may include actuating a number of moveable members extending from the housing and radially disposed around the housing and pressurizing the pumping fluid from the reservoir with fluid pumps associated with the moveable members.

The process may additionally include cycling the fluid pump at least one time for at least a predefined displacement of the moveable member in a first direction and cycling the fluid pump at least one time for at least the predefined displacement of the moveable member in a second direction.

In particular implementations, the process may include allowing the pumping fluid to pass from one side of the pistons to the other when the shaft moves in a first direction but not allow the pumping fluid to pass from one side of the piston to the other when the shaft in moves a second direction.

In another general aspect a system for utilizing movements of a fluid body to pressurize a pumping fluid for generating electrical power may include a pumping station disposed offshore. The pumping station may include a housing, a pumping fluid reservoir formed in the housing, and a plurality of pumping mechanisms disposed in the housing. The pumping fluid may at least partially fill the reservoir, and at least a portion of the pumping mechanisms may be disposed within the reservoir and at least partially immersed by the pumping fluid. Each pumping mechanism may include a movable member extending from the housing and adapted to follow movements of the fluid body, a fluid pump adapted to pressurize a pumping fluid in response to motion of the moveable member, and a power conversion mechanism coupled between the moveable member and the fluid pump. The power conversion mechanism may be adapted to cause a cycle of the fluid pump when the moveable member moves a defined distance in a first direction and a cycle of the fluid pump when the moveable member moves the defined distance in a second direction. A power generation station may be coupled to the pumping station and driven by pressurized pumping fluid.

In certain implementations, the fluid pump may includes a cylinder, a plurality of chambers formed within the cylinder, a shaft coupled to the power conversion mechanism and extending through the plurality of chambers, and a plurality of pistons coupled to the shaft, each piston disposed in a separate chamber. Each of the plurality of chambers may include a fluid inlet and a fluid outlet, which may each have a one-way valve disposed therein.

The moveable member may include a gear section, and the power conversion mechanism may include a gear meshed with the gear section and pivotable thereby. An outer diameter of the gear section may be greater than an outer diameter of the gear. The power conversion mechanism may also include a linkage having a first link and a second link, with the first link fixedly coupled to the gear at a first end and pivotably coupled to the second link at a second end. The power conversion mechanism may additionally include a wheel axis pivotably coupled to the second link and the fluid pump to drive the fluid pump. A wheel may be coupled to the wheel axis, and a guide set for the wheel may encourage linear action of the fluid pump.

Certain implementations may include a plurality of pumping stations and a conduit system. The conduit system may include a fluid output conduit and a fluid return conduit in communication with each pumping station. The output conduits may be adapted to conduct a pressurized pumping fluid from the pumping stations to the power generation station, and the return conduits may be adapted to return the pumping fluid from the power generation station to the pumping stations.

Various implementations may include one or more features. For example, as opposed to generating electrical power through burning fossil fuels (e.g., coal), electric power may be generated through using a renewable energy source and with minimal air pollution. Thus, the energy source may be used almost indefinitely and have a small effect on air quality. As another example, the energy source may be found at a variety of locations in a variety of countries. Thus, the power generation may be scaled as needed and may have widespread use. As a further example, the mechanisms used to implement the disclosed systems, processes, and techniques may provide close to continuous power and have reduced points of failure. Moreover, the mechanisms may have expanded life cycles due to enhanced lubrication and protection. Additionally, conditions that may indicate and/or cause adverse environmental conditions may be monitored and, if detected, contained.

The details of one or more implementations are set forth in the accompanying drawings and the description below. Other features will be apparent from the description and drawings, and from the claims.

### DESCRIPTION OF DRAWINGS

FIG. 1 is a perspective view of an example power generation system for converting fluid body energy into electrical power.

FIGS. 2A-D are perspective views of an example pumping station.

FIGS. 3A-B show a detailed view of an example pumping mechanism.

FIG. 4 is a schematic view of an example pumping mechanism.

FIGS. 5A-B are cross-sectional views of a portion of an example pumping mechanism.

FIGS. 6A-B are perspective cross-sectional views of a portion of an example pumping mechanism.

FIGS. 7A-D are schematic views illustrating operation of an example pumping mechanism.

FIG. 8 is a detailed view of a power conversion mechanism for a pumping mechanism.

FIGS. 9A-B are cross-sectional views of an example valve in two different operating modes.

FIG. 10 is a flow diagram illustrating an example process for generating electrical power via the movement of a fluid body.

FIG. 11 is a flow diagram illustrating another example process for generating electrical power via the movement of a fluid body.

### DETAILED DESCRIPTION

The dynamic energy of a body of fluid may be harnessed by various systems, processes, and techniques to produce useful work, such as producing electrical power. In particular implementations, systems, processes, and techniques for converting dynamic energy of a fluid body into electrical power may include the capability to use the dynamic energy to pressurize a pumping fluid and drive an electrical power generator using the pressurized fluid. The systems, processes, and techniques may, for example, use a pumping station having multiple pumps and multiple chambers per pump, which may provide a consistent, high flow. Other systems, processes, and techniques are possible, however.

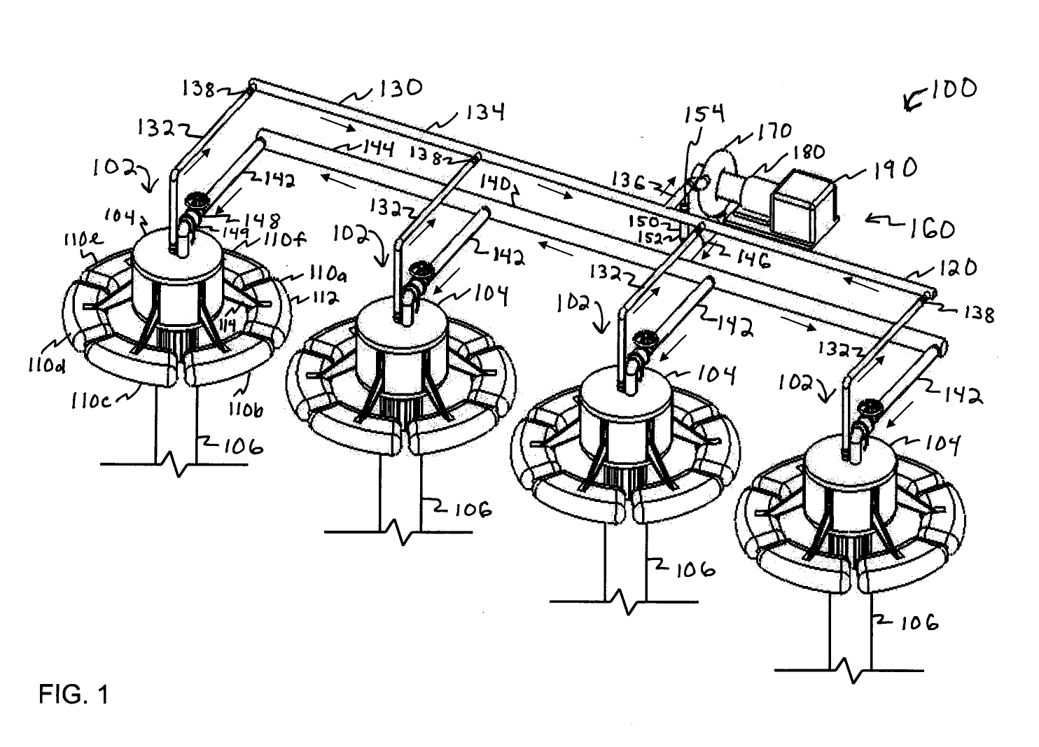

FIG. 1 illustrates one example of a system 100 for converting fluid body energy to electrical power. The system 100 includes one or more pumping stations 102 located in a fluid body (e.g., a lake, sea, or ocean) and a power generation station 160. As described in more detail below, each pumping station 102 includes a plurality of radially disposed fluid pumping mechanisms (“pumping mechanisms”) 110 that are actuated by the movement of the fluid body to pressurize a pumping fluid that is used to drive the power generation station 160, which produces electrical power.

Each pumping station 102 is supported by a piling 106. The pilings 106 may be anchored to, embedded in, or otherwise coupled to the bottom of the fluid body. The pilings 106 may be formed from wood, concrete, metal, composite, or any other suitable material. The pilings 106 may support the pumping stations 102 so that they are generally above the surface of the fluid body. However, the pumping stations 102 may be at least partially submerged or completely submerged in the fluid body, especially due to changing conditions (e.g., tides, waves, etc).

Each pumping mechanism 110 includes a buoyant member 112 attached to an arm 114, which defines at least part of an elongated member. Together, a buoyant member 112 and an arm 114 define at least a portion of a moveable member of a pumping mechanism 110 for following a movement of a fluid body. As explained in greater detail below, the pumping mechanisms 110 are operable to pressurize (e.g., pump) a pumping fluid, such as a hydraulic oil.

Fluid motion of the fluid body in which a pumping station 102 is disposed may, for example, be wave motion. As a wave passes the pumping station 102, the buoyant members 112 on a wave-front-facing side of the pumping station 102 encounter the wave first, while the buoyant members on a wave-tail-facing side of the pumping station 102 encounter the wave last. Thus, the buoyant members 112 on the wave-front-facing side rise as the wave arrives at the pumping station 102, and, a short time later, other buoyant members 112 disposed around the pumping station 102 adjacent the buoyant members 112 on the wave-front-facing side also begin to rise. As the wave continues, the buoyant members 112 on the wave-tail-facing side also begin to rise. A wave may, therefore, generate a staggered pumping action.

In some implementations, the buoyant members 112 on the wave-front-facing side may be at the wave crest as the buoyant members 112 on near the wave-tail-facing side begin to encounter the wave. Thus, because the pumping mechanisms 110 are individually actuated, some buoyant members 112 of the pumping station 102 may be rising while others are falling. Consequently, the pumping station 102 may produce an essentially continuous output of pumping fluid, depending upon the wave conditions of the fluid body.

The pumping mechanisms 110 are coupled to the power generation station 160 by a conduit system 120, which conveys the pressurized pumping fluid to the power generation station 160. The power generation 160 station includes a fluid-mechanical power converter 170 (e.g., a turbine) that is driven by the pressurized pumping fluid. The fluid-mechanical power converter 170 drives a shaft 180 that is coupled to a power generator 190, which generates electrical power based on being driven by the shaft.

The power generation station 160 is typically provided on a shore of a fluid body, but may be provided at other locations. For example, one or more components of the power generation station may be provided on a piling located in the fluid body.

The conduit system 120 includes an output conduit system 130 and a return conduit system 140. The output conduit system 130 includes output conduits 132 to carry pressurized pumping fluid away from the pumping stations 102, and the return conduit system 140 includes return conduits 142 to carry depressurized pumping fluid back to the pumping stations 102. An output conduit 132 and a return conduit 142 are in fluid communication with each pumping station 102. As shown, the output conduits 132 are coupled to a common manifold 134. A converter supply conduit 136 extends between the common manifold 134 and the fluid-mechanical power converter 170. The return conduits 142 are also coupled to a common manifold 144, which is connected to the fluid-mechanical power converter 170 via a converter return conduit 146.

The conduit system 120 may also include a bypass system 150 that couples the output conduit system 130 and the return conduit system 140. In the illustrated implementation, the bypass system 150 includes a bypass conduit 152 that extends between the converter supply conduit 136 and the converter return conduit 146 to allow fluid communication between the two. The bypass conduit 152 includes a pressure-activated valve 154 disposed therein, which may, for example, be a pressure relief valve. Consequently, if a pressure in the converter supply conduit 136 exceeds a selected pressure, the valve 154 may open, causing all or a portion of the pressurized pumping fluid to be conveyed into the converter return conduit 146. In other implementations, the bypass system 150 could be positioned in other locations—between the common manifolds 134 and 144, for example.

Each return conduit 142 may include one or more shutoff valves. As illustrated, the return conduits 142 include a valve 148 and a valve 149. These valves, which will be discussed in more detail below, may be useful for emergency shutdowns or during maintenance, repair, or replacement.

The output conduit 132 may also include a check valve 138 disposed, for example, near the common manifold 134, as shown in FIG. 1. The check valve 138 may prevent backflow of the pumping fluid through the output conduit 132.

In this implementation, the output conduit 132 has a smaller diameter than the return conduit 142 because the pumping fluid passing through the output conduit 132 has a higher fluid pressure than the pumping fluid passing through the return conduit 142. However, the conduits 132, 142 may be any size. For example, the output conduits 132 may be larger than the return conduits 142 or the same size.

The fluid-mechanical power converter 170 is coupled to the shaft 180 and is driven by the pressurized pumping fluid from the output conduits 132. In the illustrated implementation, the fluid-mechanical power converter is rotates the shaft 180 when driven by the pumping fluid. The rotation of shaft 180 drives the power generator 190 to generate electrical power. The power generator may be of conventional design.

The pumping fluid is then returned to the pumping stations 102 via the converter return conduit 146, the common manifold 144, and the respective return conduits 142. The pumping fluid is returned to the housings 104 for subsequent use. The pumping fluid in the return conduit system 140 may be returned to the housings 104 through positive pressure, negative pressure, and/or gravity.

The power generation system 100 has a variety of features. For example, as opposed to generating electrical power through burning fossil fuels (e.g., coal), electric power may be generated through using a renewable energy source, with little, if any, air pollution. Thus, the energy source may be used almost indefinitely and have a small effect on air quality. As another example, the energy source may be found at a variety of locations in a variety of countries. Thus, the power generation may be scaled as needed and may have widespread use. The system 100 also provides the benefits of occupying a small area in which the pumping stations can be tightly packed. Additionally, the pumping stations 102 can control leaks, since the pumping mechanisms 110 of a pumping station 102 are contained within a common housing 104. In some implementations, the pumping stations 102 are lightweight and easy to manufacture.

Other implementations of power generation system 100 may have additional features. For example, as discussed in more detail below, conditions that may indicate and/or cause adverse environmental conditions may be monitored and, if detected, contained. For instance, appropriate sensors could detect contamination/leakage of the pumping fluid and use isolation mechanisms (e.g., valves) to stop the flow of pumping fluid to and/or from a pumping station 102 or a fluid-mechanical power converter 170. As another example, the pumping fluid could be biodegradable. Thus, the power generation system 100 may provide a minimal impact on the environment if a problem does arise.

Although four pumping stations 102 are illustrated in FIG. 1, other implementations may include fewer or additional pumping stations. Additionally, although FIG. 1 shows that the pumping stations 102 pump the pumping fluid to a single fluid-mechanical power converter 170, other configurations are also possible. For example, each pumping station 102 may be exclusively coupled to a single fluid-mechanical power converter 170, i.e., the pumping stations 102 and the fluid-mechanical power converters 170 may be in a one-to-one correspondence. Further, numerous fluid-mechanical power converters 170 and/or power generators 190 may be provided, and the pumping stations 102 may be coupled to the fluid-mechanical power converters 170 in a many-to-one correspondence. Additionally, although FIG. 1 shows the pumping stations 102 having six pumping mechanisms 110, a pumping station 102 may include fewer or additional pumping mechanisms 110 in other implementations.

The pumping stations 102, as well as the fluid-mechanical power converter 170, the various conduits, the shafts 180, and the power generator 190, may be sized according to an intended application, taking into consideration factors such as an amount of power to be generated, the size of the average fluid body movements (e.g., waves) to be experienced, the distance from shore of the pumping stations 102, the difference in height from the pumping stations 102 to the fluid-mechanical power converter 170, etc. In general, therefore, the pumping stations 102 may be placed at various distances from shore. Moreover, in certain implementations, one or more pumping stations 102 may be utilized far from shore. For example, the pilings 106 may support the pumping stations 102 within a depth of the fluid body, and the associated generator 190 may be provided on an offshore platform.

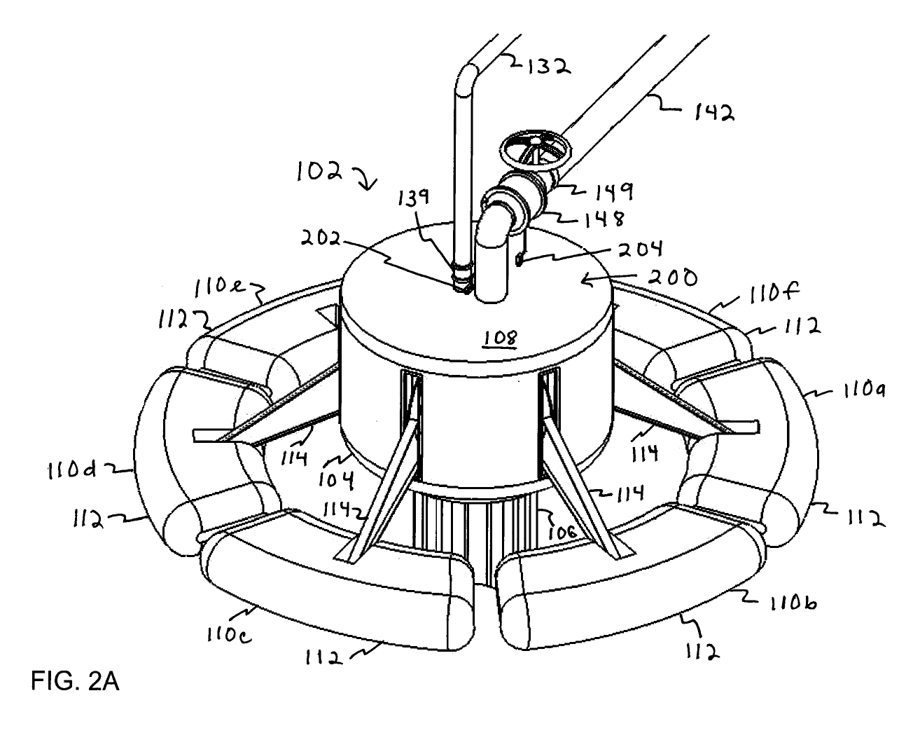

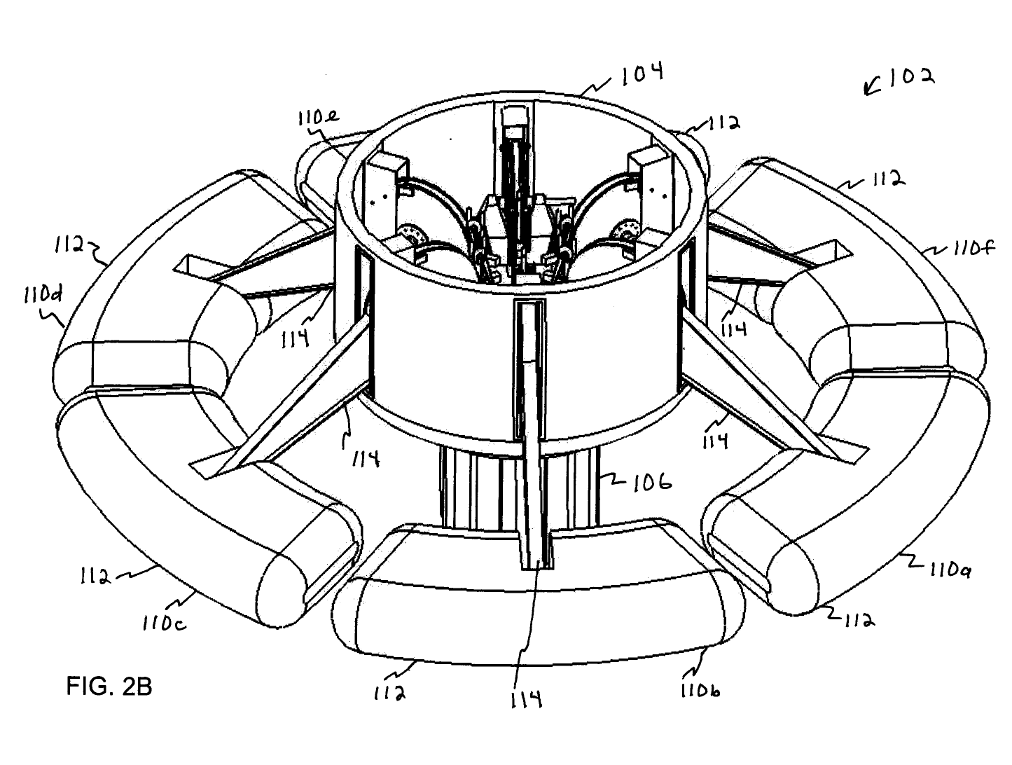

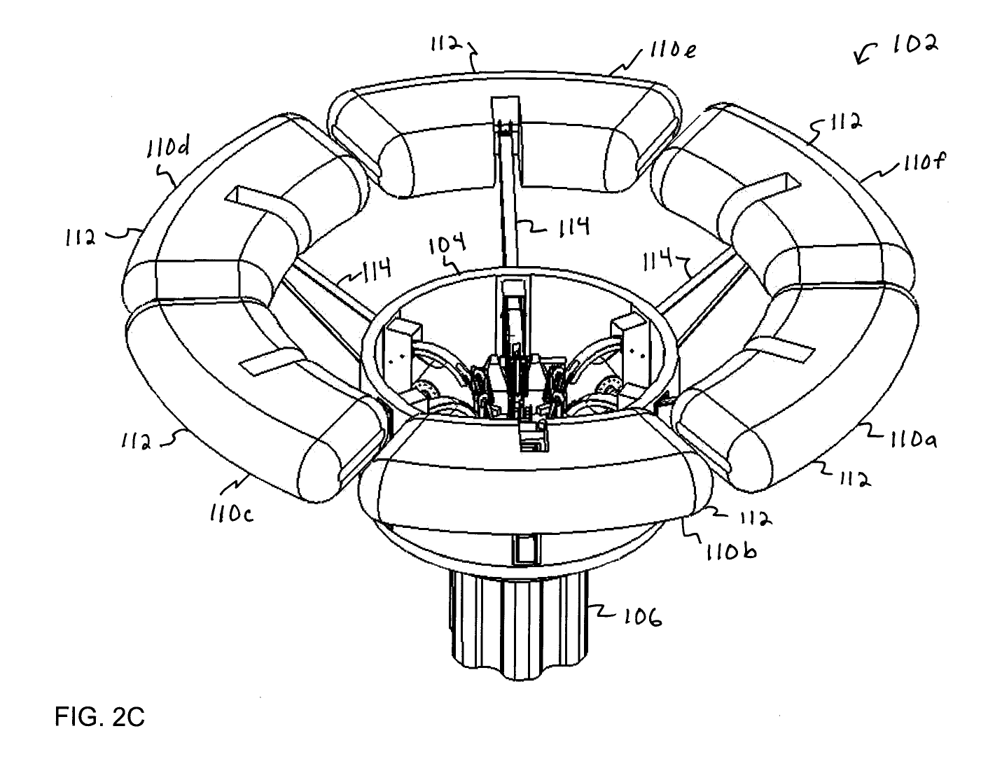

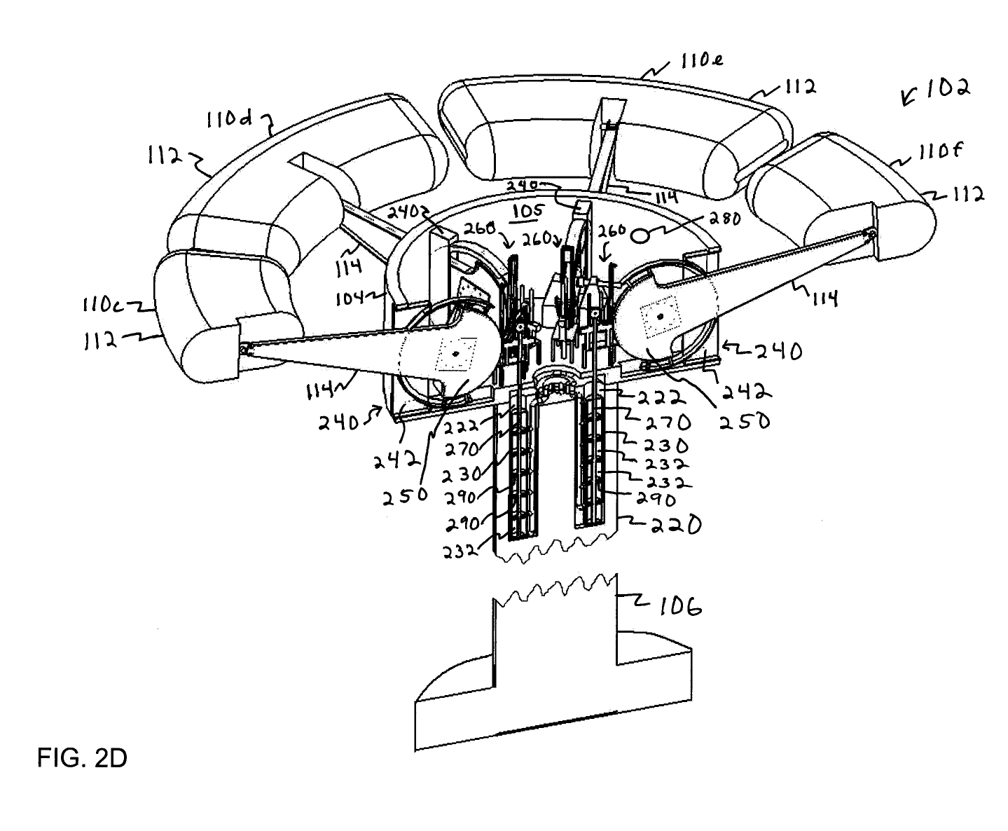

FIGS. 2A-D show various views of an example pumping station 102. As mentioned above, the pumping station 102 includes a plurality of pumping mechanisms 110 radially disposed about a piling 106. The buoyant members 112 of the pumping mechanisms 110 are disposed about a periphery of the pumping station 102.

The buoyant members 112 may be pivotably coupled to their respective arms 114 so that the buoyant members 112 can articulate as the buoyant members 112 follow a movement (e.g., wave) of a fluid body. In other instances, the buoyant members 112 may be fixedly attached to their respective arms 114. Although the buoyant members 112 are shown with a generally flattened shape, the buoyant members 112 may be any shape, such as, for example, a sphere, ellipsoid, square, pyramid, or rectangle. Further, in some instances, the buoyant members 112 may also have an internal structure and may have any form to provide rigidity to the buoyant member 112 while also allowing the buoyant member 112 to remain buoyant. Air or foam, such as, polyurethane foam, may also be included in the buoyant member 112. The buoyant members may cause arms 114 to articulate due to movements of the fluid body, which may include waves, swells, and/or any other appropriate type of fluid body movements.

The arms 114 may be formed from metal, such as stainless steel, aluminum, or any other appropriate material. The arms 114 may also be formed from a composite material, such as concrete, fiberglass, wood, carbon fiber, polyaramide fiber, or any other appropriate composite material. Further, the arms 114 may be coated to protect them from the environment and limit or prevent corrosion.

The pumping mechanisms 110 may also include a buoyant member release mechanism. The release mechanism may include a cable, rope, or other flexible member extending between the buoyant member 112 and the arm 114. The release mechanism may be utilized in adverse weather, such as a hurricane or tsunami, or any other weather or fluid body condition that may cause damage to the pumping mechanism 110 (e.g., by causing the arm to articulate too quickly or over too large of an angular displacement). When triggered, the release mechanism may cause the buoyant members 112 to release from the arms 114. The buoyant members 112 may be prevented from floating away and being lost by the flexible members extending between the associated buoyant member 112 and the arm 114.

The flexible member may be any suitable length to permit the buoyant members 112 to rise and fall with a fluid body's movements while simultaneously preventing the arms 114 from being articulated therewith. The release mechanism may be automatically triggered when large waves or other extreme conditions are experienced. For example, when forces on the buoyant members 112 by the wave motion exceed a predetermined value, a bolt or other structure may shear or otherwise disconnect, releasing the buoyant members 112 from the arms 114.

The output conduit 132 for the pressurized pumping fluid and the return conduit 142 for the depressurized pumping fluid are coupled to the pumping station 102 through a cover 108 of the housing 104. Valves 148, 149 are included in the return conduit 142.

The pumping station 102 may also have associated therewith a sensor system 200. In the illustrated implementation, sensor system 200 includes a contamination sensor 202 that detects a contaminant in the pumping fluid, such as a selected amount of water or other contaminant, and a flow rate sensor 204.

As illustrated in FIG. 2A, the contaminant sensor 202 is coupled to the output conduit 132 to detect contamination of the pumping fluid being pumped out of the pumping station 102. However, according to other implementations, the sensor 202 may be disposed in other locations, such as within an interior of the housing 104. When the sensor 202 detects contamination of the pumping fluid, the sensor 202 may send a signal to an operator, who may take appropriate action, and/or a signal from the sensor 202 indicating the presence of a contaminant may be sent to a valve, disposed in the output conduit 132, for example, that is operable to stop flow of the pumping fluid out of the pumping station 102. A contamination signal from the sensor 202 may also cause an actuator of the valve 148 to activate, thereby closing the valve 148 and stopping flow of the pumping fluid through the return conduit 142 to the pumping station 102. Thus, in some instances, the sensor 202 may be used to isolate a pumping station 102 when a predetermined condition is detected, such as the presence of contamination in the pumping fluid. In certain implementations, other sensors may be incorporated into the pumping station 102 to isolate the pumping station 102 on the occurrence of a selected event or condition (e.g., presence of a leak or contamination).

Each pumping station 102 may also include one or more flow rate sensors 204 in the return conduit 142, as illustrated in FIG. 2A. In some implementations, the flow rate sensors 204 may be incorporated into one of valve 148 or valve 149. In other implementations, the flow rate sensors 204 may be a separate device disposed in the return conduit 142. A flow rate sensor may also be provided in the output conduit 132. The flow rate sensor(s) may measure a flow rate of the pumping fluid passing through the output conduit 132 and/or the return conduit 142. According to some implementations, the flow rate sensor(s) may transmit a signal indicating the measured flow rate of the pumping fluid to a controller, which may be locally or remotely located. The flow rate measurements may be compared, and an alarm may be triggered if a difference between the flow rate measurements exceeds a selected amount. For example, the flow rate sensor(s) may transmit the flow rate measurements to a controller that can compare the measurement values and determine if a difference, if any, exceeds a predetermined amount, which may, for example, indicate a leak. Further, the controller may open or close one or more valves, e.g., valve 148 and/or one or more other valves provided in the output conduit 132 and/or return conduit 142, in order to adjust an amount of the pumping fluid conveyed to or from the pumping station 102 or stop flow of the pumping fluid to or from the pumping station 102, or both. The controller may be a mechanical or electronic device operable to receive, analyze, and transmit signals. In some implementations, the controller may be assisted by a human (e.g., to make a shut-down decision).

One or more of the sensors of sensor system 200 may be adapted to provide an alarm signal when the predetermined condition is detected. For example, the sensor 202 may send the alarm signal to one or more illumination devices disposed on the pumping station 102. Further, the alarm may be transmitted via a wired or wireless connection to a remote site to indicate the occurrence of the predetermined condition.

Power to the sensors in the sensor system 200, one or more of the valves described above, or other devices may be provided, for example, by a power line, battery, or any other power source, such as solar power.

A bypass line, such as a conduit extending between the output conduit 132 and the return conduit 142, may also be included. In other implementations, a bypass line may be internal to the pumping station 102 to keeping pumping fluid back into the housing 104. The bypass line may be triggered when a condition or event occurs (e.g., the presence of a leak or contamination) so that the pumping fluid may be recirculated after one or more of the valves described herein, e.g., valve 148 (discussed below), have been triggered. Because the pumping mechanisms 110 may continue to operate, the bypass line permits the pumping fluid to recirculate, thereby avoiding damage that may otherwise result if all or part of the pumping station 102 were isolated from the system 100 while the pumping mechanism 110 remained operational.

Valve 149 may be used during maintenance, repair, or replacement operations. The valve 149 may be manually actuated—via a hand-crank, for example. During normal operations, the valve 149 may be in an open condition, permitting pumping fluid to flow therethrough. However, the valve 149 may be closed at certain times, thereby preventing the flow of pumping fluid into the housing 104. For example, the valve 149 may be closed in order to remove or perform maintenance on the valve 148 and/or pumping mechanism 110. Consequently, closing one or more of valves 148 and 149 at least partially isolates the corresponding pumping station 102.

The output conduit 132 may also include a check valve that permits the flow of pumping fluid out of the pumping station 102 but prevents backflow of the pumping fluid through the output conduit 132 and into the pumping station 102. Further, the output conduit 132 may also include one or more valves similar, for example, to valve 149, to aid in isolating the pumping station 102 from the remainder of the system 100. Similar to valve 149, such a valve may be closed in order to remove, repair, or maintain the pumping station 102.

The pumping station 102 may be removable for maintenance, repair, or replacement, one or more shut-off valves (such as valve 149) may be disposed on opposite sides of a disconnect, which may, for example, be a pair of flanged ends abutting one another or any other mechanism for detaching one end of a conduit from another end. When disconnecting the pumping station 102 from the output conduit 132 and the return conduit 142, the shut-off valves may be closed and the disconnect(s) uncoupled. Consequently, pumping fluid is prevented from entering or leaving the pumping station 102 or the output or return conduits 132, 142.

The pumping stations 102 may also include a gas release to release any gas (e.g., air) trapped or otherwise contained within the housing 104 into the atmosphere. The gas release may, for example, include a pressure release valve and a conduit to convey the gas to the atmosphere.

FIGS. 2B-C show the pumping station 102 with the cover 108 removed and with the arms 114 in a lowered and raised position, respectively. As can be seen, the arms 114 pivot inside housing 1034 in response to movement of a fluid body, which causes the buoyant members 114 to raise and lower. It is noted that, although FIGS. 2B-C show all of the arms 114 fully lowered or fully raised together, the arms 114 of a pumping station 102 may articulate independently of each other. Thus, while some arms 114 may be in a raised position, other arms 114 may be in a lowered or intermediate position. This may, for example, occur as a wave passes the pumping station 102. Further, the arms 114 may articulate at different rates.

FIG. 2D shows a cross-sectional view of the pumping station 102. In this view, the cover 108 is removed, exposing an opening at a first end. The opening is covered by the cover 108 when attached to the pumping station 102 and may form a seal to prevent contaminants from entering the housing 104. In some instances, a watertight seal is formed between the cover 108 and the housing 104. The housing 104 also includes a lower portion 220 that has a plurality of elongated chambers 222 that house multi-chambered cylinders (“cylinder”) 230 (described in more detail below) for pumping the pumping fluid. Each cylinder 230 is part of a pumping mechanism 110.

The pumping mechanisms 110 are disposed in a radial configuration around the periphery of the housing 104. The arms 114 of the pumping mechanisms 110 are pivotably coupled within the pumping station 102 and extend through the housing 104 through slots 240. The arms 114 also extend through sealing sleeves 242 in the slots 240 to isolate the interior of the housing 104 from the environment. For example, the sealing sleeves 242 prevent penetration of water, such as ocean water and rain, into the housing 104 while also preventing pumping fluid from exiting the housing 104 through the slots 240.

The housing 104 also forms a reservoir 105 for holding the pumping fluid. As illustrated, various components of the pumping mechanisms 110 (e.g., the gear 250, power conversion mechanism 260, and the shaft 270) may also be disposed in the reservoir. Thus, these components may be at least partially in contact with (e.g., immersed in) the pumping fluid. The contact with the pumping fluid may provide the pumping mechanism 110 an expanded life cycle due to enhanced lubrication and protection. The pumping fluid may also provide a cooling function for components of the pumping mechanism 110 due to the circulation of the pumping fluid.

A fluid level sensor 280 may also be included to monitor a pumping fluid level in the housing 104. A signal from the fluid level sensor 280 may be used to determine if a leak is present in the system 100, such as if the depth of pumping fluid is diminishing over time, or if the amount of pumping fluid is inadequate. Further, a signal from the fluid level sensor 280 may be used to control one or more functions of the system 100, such as to prevent fluid flow to or from the pumping station 102 by actuation of one or more valves.

Each pumping mechanism 110 includes a buoyant member 112, an arm 114, a gear 250 disposed at an end of the arm 114 opposite the buoyant member 112, a power conversion mechanism 260 in intermeshing engagement with the gear 250, an elongated shaft 270 driven by the power conversion mechanism, and the cylinder 230. As illustrated, the gear 250 is arc-shaped, but the gear 250 may have other shapes. The shaft 270 acts as a piston rod for the cylinder 230.

Each shaft 270 drives a number pistons 290, to be discussed in more detail below, in each cylinder 230. (Each position 290 has an associated chamber 232 in the cylinder 230.) Thus, the articulation of the arm 114 by buoyant member 112 causes multiple pistons 290 to pressurize pumping fluid from the reservoir 105. The use of multiple pistons allows for a smaller articulation of the arms 114 to be able to move a large amount of fluid as a small articulation can cause the entire column of fluid in the cylinder 230 to be pressurized. Moreover, this can provide for smaller components (e.g., pistons) and protect against single-point failures.

During operation, the buoyant members 112 follow the movements of the fluid body, causing the buoyant members 112 to rise and fall and the arms 114 to pivot. As the arms 114 pivot, the gears 250 rotate accordingly, which, in turn, activates the power conversion mechanisms 260. The power conversion mechanisms 260 drive the shafts 270, causing the pistons 290 in each cylinder 230 to reciprocate within their respective chambers 232. As a result, the pumping fluid is pumped out of the pumping stations 102 through the output conduits 132, from which it case be directed to a power generation station.

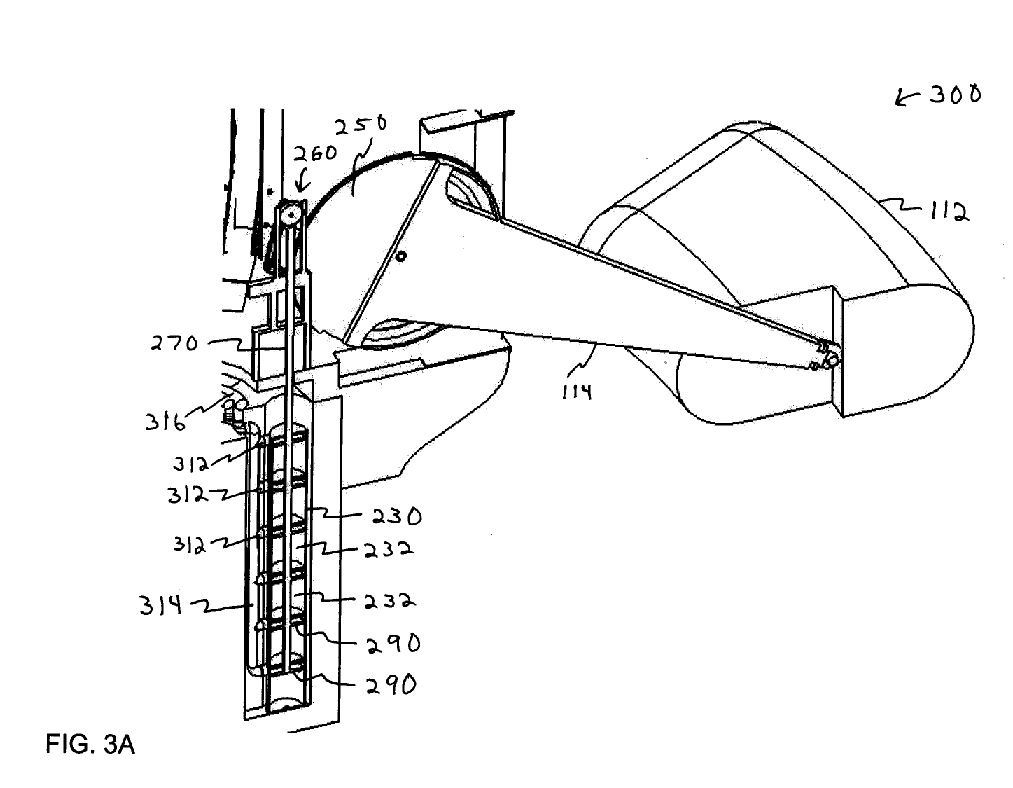

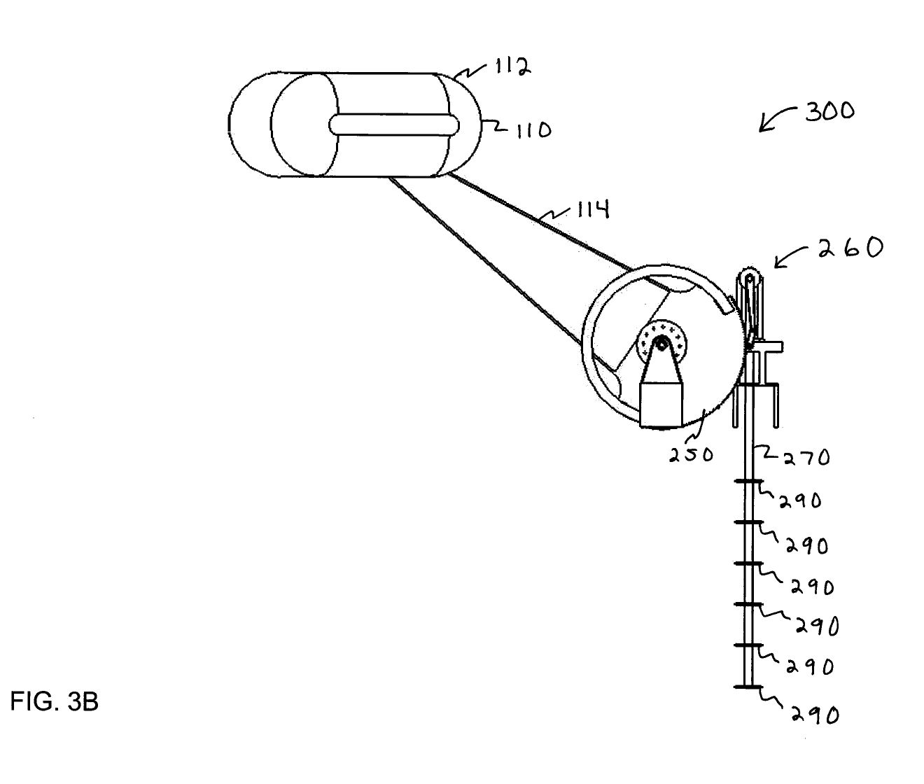

FIGS. 3A-B illustrate an example pumping mechanism 300. Similar to the pumping mechanism in FIGS. 2A-D, the pumping mechanism 300 includes a buoyant member 112, an arm 114, and a first gear 250 disposed at an end of the arm 114 opposite the buoyant member 112, a power conversion mechanism 260 in intermeshing engagement with the gear 250, and an elongated shaft 270 that extends into the cylinder 230.

The cylinder 230 includes a number of chambers 232, each of which has an associated piston 290. Each piston 290 resides in a separate chamber 232 of the cylinder 230, and each of pistons 290 is coupled to the shaft 270. The shaft 270 acts as a piston rod for the cylinder 230. Each chamber 232 includes an inlet 312 for allowing pumping fluid to enter the chamber and an outlet (not explicitly shown) for allowing pumping fluid to exit the chamber. The inlets 312 are in fluid communication with a common manifold 314. The common manifold 314 for each cylinder 230 may be in fluid communication with a feed manifold 316, which communicates pumping fluid from a reservoir to each of the common manifolds 314.

In operation, as the shaft 270 moves the pistons 290, pumping fluid is drawn into the chambers 232 from the common manifold 314 through the inlets 312. The pumping fluid may then be forced out of the chambers 232 by the pistons 290 through the outlets. In certain implementations, movement of the shaft 270 in one direction draws pumping fluid into the chamber 232, and movement of the shaft 270 in a second direction forces the pumping fluid out of the chamber. This may, for example, occur with a single-action pump. In other implementations, movement of the shaft 270 in one direction draws pumping fluid into the chamber 232 and forces the pumping fluid out of the chamber. This may, for example, occur with a double-action pump.

As illustrated, the gear 250 is arc-shaped. However, the gear 250 may have other shapes. Additionally, the diameters and number of teeth of the gear 250 and the power conversion mechanism 260 may be sized, for example, based on the size of the expected motion of the body of water in which the pumping mechanism 300 is disposed. Further, the gear 250 and the power conversion mechanism 260 may be sized to produce a desired number of pumping cycles of the pistons per upward or downward movement of the arm 114.

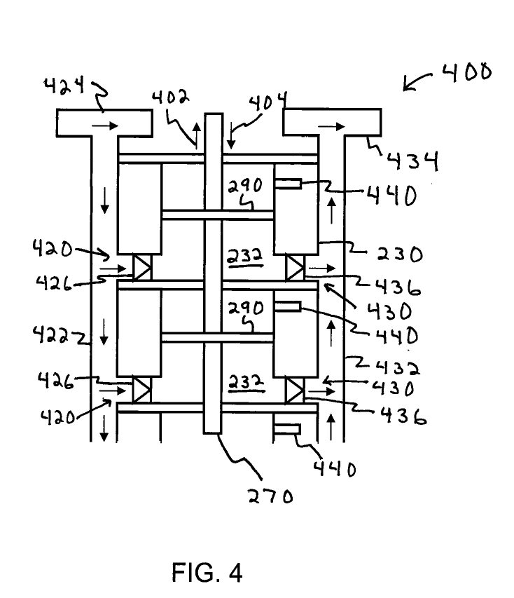

FIG. 4 illustrates an example pumping mechanism 400. As illustrated, the cylinder 230 includes a number of chambers 232, each of which has an associated piston 290. Each piston 290 resides in a separate chamber 232 of the cylinder 230, and each of pistons 290 is attached to the shaft 270, which acts as a piston rod for the cylinder 230. Each chamber 232 includes an inlet 420 for allowing pumping fluid to enter the chamber and an outlet 430 for allowing pumping fluid to exit the chamber. The inlets 420 are in fluid communication with a common manifold 422. The common manifold 422 for each cylinder 230 may be in fluid communication with a feed manifold 424, which communicates with a reservoir of pumping fluid. The outlets 430 are in fluid communication with a common manifold 432. The common manifold 432 for each cylinder 230 may be in fluid communication with a output manifold 434. The output manifold 434 is coupled to an output conduit. Thus, the pumped fluid passes out of the chambers 232, through the outlets 430, and into the common manifold 432. The pumped fluid flowing through the common manifold 432 of each cylinder 230 passes into an output manifold 434 and out through an output conduit.

Each inlet 420 and each outlet 430 includes a check valve (i.e., a one-way valve) 426 and 436, respectively, to permit fluid flow in only one direction. Thus, in operation, as the shaft 270 and associated pistons 290 move in a direction indicated by arrow 402, pumping fluid is drawn into the chambers 232 through the inlets 420 and check valves 426. However, the check valves 436 prevent pumping fluid from entering through the outlets 430. When the shaft 270 and pistons 290 travel in the direction indicated by arrow 404, the pumping fluid is forced out of the chambers 232 through the outlets 430 and check valves 436. The check valves 426 prevent flow of pumping fluid out of the chambers 232 through the inlets 420. The chambers 232 may also include a vent 440 to equalize pressure in the chambers 232 during operation. In some implementations, the vents 440 may be in communication with the atmosphere.

As described above, the cylinder 230 and associated pistons 290 of the pumping mechanism 400 act as a single-action pump. However, in certain implementations, the cylinder 230 and associated pistons 290 may be configured to operate as a double-action pump, such as by including a fluid inlet and outlet, along with corresponding one-way valves, at opposing ends of each cylinder chamber. Additionally, other types of pumping mechanisms are possible. Thus, any appropriate pump for pumping a pumping fluid may be used.

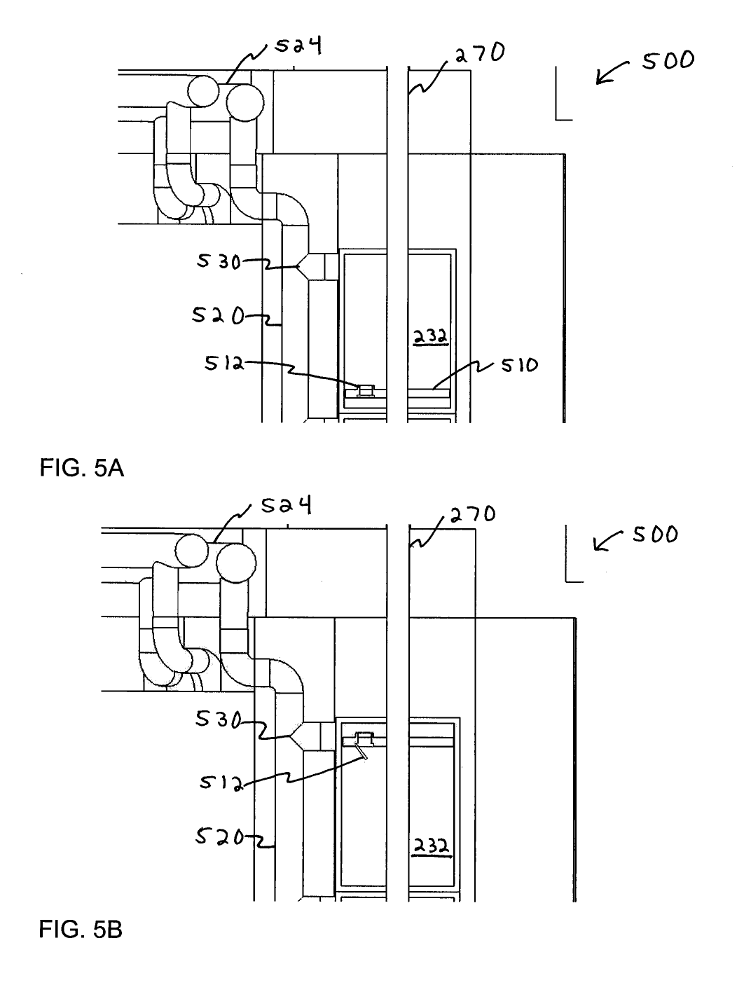

FIGS. 5A-B illustrate a portion of an example pumping mechanism 500. In this implementation, a piston 510 includes at least one one-way valve 512 (e.g., a check valve), the operation of which is described below. FIG. 5A show the piston 510 at a lower position within a chamber 232, and FIG. 5B shows the piston 510 at an upper position within the chamber 232. FIGS. 5A-B also show a common manifold 520 that feeds pumping fluid to the chamber 232 via the inlet 530. The common manifold 520 is connected to a feed manifold 524, which may be coupled to a reservoir of pumping fluid. The outlets for the chambers 232 are not shown here because of the cross-sectional cut through the cylinder 230.

In operation, the one-way valve 512 is closed during a power stroke of the piston 230 within the chamber 232. As illustrated, this occurs when the piston is moving downward. Because the valve 512 is closed, the piston 510 pressurizes the pumping fluid in the chamber 232 and forces it to move out an outlet, and eventually to the power generation station. At the same time, pumping fluid is entering the chamber 232 behind the piston, through inlet 530. Thus, pressure differentials across the piston may be reduced. As the piston 510 is driven in the other direction, however, the pumping fluid behind the piston is pressurized and flows from one side of the piston to the other through one-way valve 512. The pumping fluid is prevented from flowing back out through the inlet by one or more valves. Thus, when the piston 510 arrives at the top of the chamber, it is ready for another full power stroke.

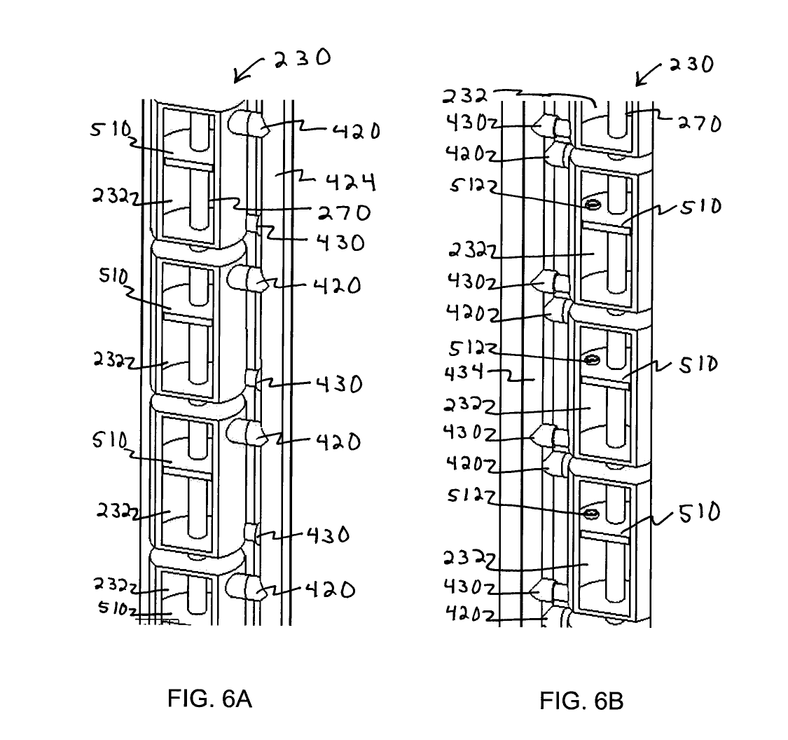

FIGS. 6A-B provide three-dimensional cross-section views of a cylinder 230 containing a number of chambers 232. FIG. 6A shows a front view of the cylinder 230, and FIG. 6B shows a back view the cylinder. Each chamber 232 has an associated piston 510 that includes at least one one-way valve 512. Each chamber 232 is fed pumping fluid by an inlet 420, which is coupled to a common manifold 424 that feeds pumping fluid to the inlets 430. The pressurized fluid from each chamber 232 is released through one of outlets 430, which are coupled to a common manifold 434.

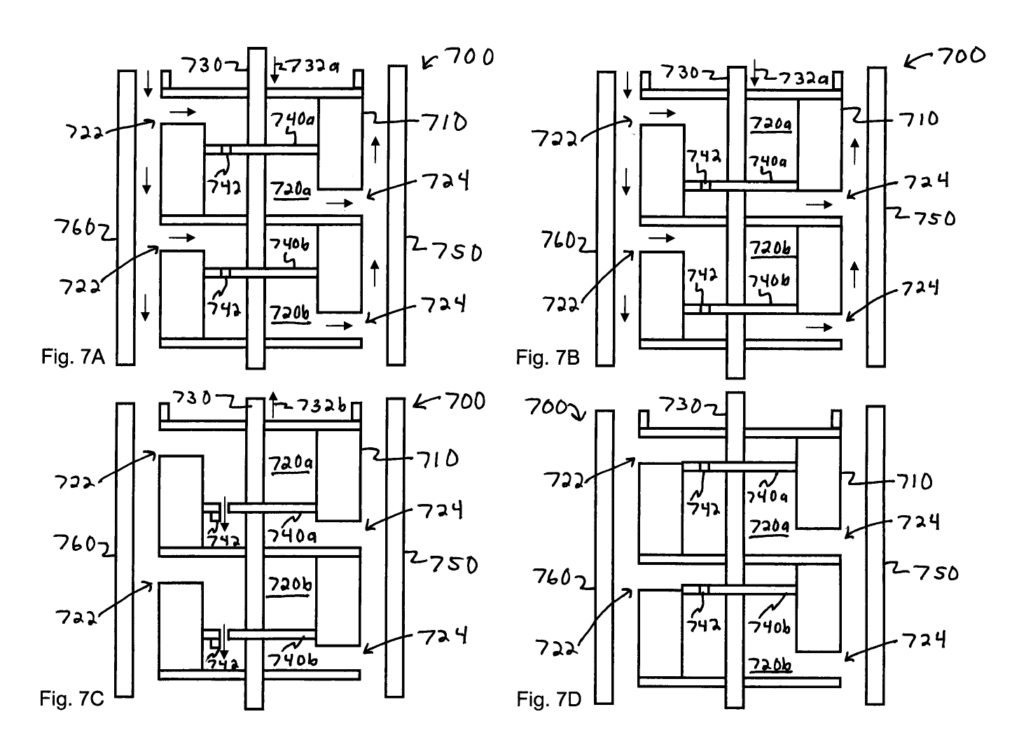

FIGS. 7A-D illustrate the operation of an example pumping mechanism 700. Pumping mechanism 700 includes a cylinder 710 that has a number of chambers 720. Each chamber includes an inlet 722 and an outlet 724 for allowing pumping fluid to enter and leave the chamber respectively. The pumping mechanism 700 also includes a shaft 730 that has a number of pistons 740 coupled thereto, and each piston 740 includes a valve 742.

FIGS. 7A-B illustrate a power stroke for the pistons 740. During this stroke, the shaft 730 is moving in the direction of arrow 732a. The pistons 740 are also being driven in the same direction within the chambers 232 by the shaft 730, and the valves 732 in the pistons are closed. Thus, the pistons 740 are pressurizing fluid ahead of the pistons and moving towards the outlets 724. As the pistons 740 are driven towards the outlets 724, the pumping fluid is forced out of the chambers 720 through the outlets 724 and into a common manifold 750 until the pistons 740 reach a position near the outlets 724, as shown in FIG. 7B. Additionally, as the pistons 740 are driven towards the outlets 724, pumping fluid is drawn into the chambers 720 from a common manifold 760 via the inlets 722. Thus, pumping fluid fills the volume behind the pistons 740 during the power stroke, and the valves 742 in the pistons 740 are in a closed position during this stroke so that pumping fluid on opposite sides of the pistons 740 is separated.

Once the pistons 740 reach the end of their stroke, as determined by the movement of the shaft 730, the pistons are ready for a return stroke, which is illustrated in FIG. 7C. As illustrated, the shaft 730, as well as the pistons 740, moves in the direction of arrow 732b during the return stroke. That is, the pistons 740 move away from the outlets 724 and towards the inlets 722. The valves 742 of the pistons 740 are now in an open configuration to permit the pumping fluid that accumulated behind the pistons during the power stroke to pass through the pistons. This allows pumping fluid to be in place to be pumped during the subsequent power stroke. Moreover, this assists in equalizing the pressure on both side of the piston (e.g., by preventing or reducing any vacuums).

FIG. 7D shows the pistons 740 near the inlets 722 of the chambers 720. As shown, the valves 742 have returned to the closed position in advance of the subsequent power stroke. According to some implementations, the valves 742 may be biased in the closed position so that they return to a closed position when pressures on opposing sides of the pistons 742 have equalized or substantially equalized. In other instances, the valves 742 may be closed by motion of the pistons 740 during the power stroke.

The flow of the pumping fluid into and out of the chambers 720 may be controlled by valves for the inlets 722 and the outlets 724. For example, check valves in the inlets 722 may allow pumping fluid to enter the chambers during the power stroke and prevent pumping fluid from leaving the chambers during the return stroke. Additionally, check valves in the outlets 724 may allow pumping fluid to leave the chambers during the power stroke and prevent pumping fluid from entering the chambers during the return stroke.

The chambers 720 shown in FIGS. 7A-D illustrate a one action per cycle pump. That is, the pistons 740 alternate between a power stroke (movement of the pistons 740 towards the outlets 724) and a refill stroke (movement of the pistons 740 towards the inlets 722) during a cycle. In other implementations, other types of pumping actions (e.g., dual actions) may be used.

Depending on the action of the fluid body, which is likely variable over time, strokes may or may not be full strokes. For example, if the action of the fluid body is light, many strokes, and sometimes even most, if not all, may be less than full. As another example, if the action of the fluid body is heavy, some strokes may be full and some strokes may be partially full. The alteration between full strokes and partial strokes does not affect the ability of the system to pump fluid, although the rate and/or pressure may be higher or lower.

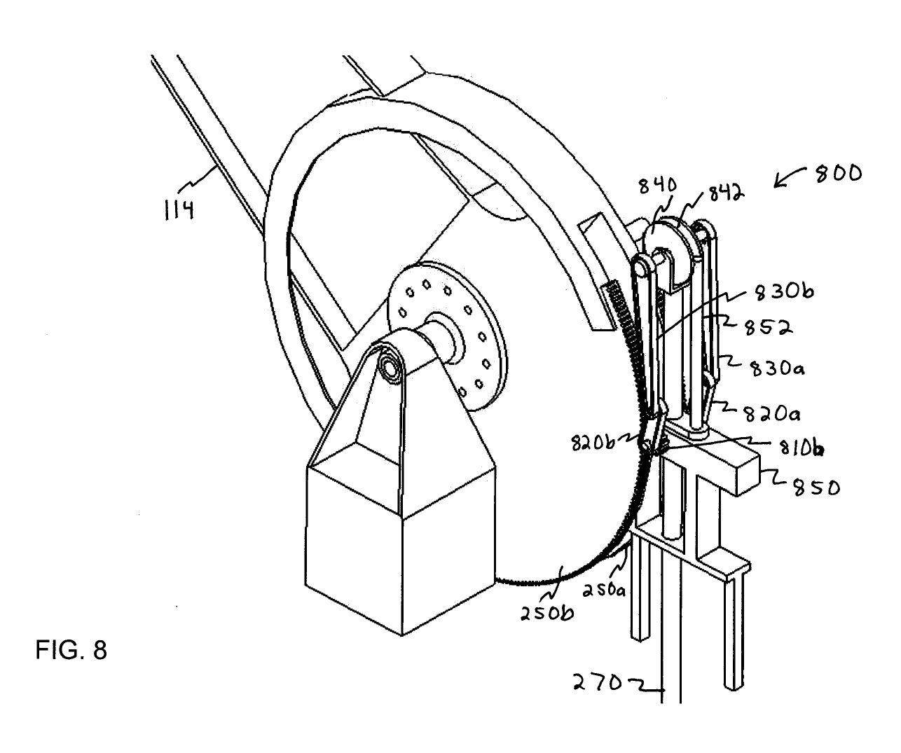

FIG. 8 illustrates a power conversion mechanism 800 for use with a pumping mechanism. In this implementation, power conversion mechanism 800 converts the rotary motion of arm 114 into linear motion for driving the shaft 270.

As illustrated, the shaft 114 has two arcuate gear sections 250. The gear sections 250 mesh with gears 810 of the power conversion mechanism 800. Thus, the power conversion mechanism is driven by the movement of the arm 114. The gears 810 are coupled to first linkages 820 and drive the linkages in a rotational manner about one of their ends. The first linkages 820 are pivotally coupled to an end of respective second linkages 830 at another end and drive that end of the second linkages 830 in an arcuate manner. Another end of the second linkages 830 is pivotally coupled to the axis of a guide wheel 840. The shaft 270 is also coupled to the axis of the guide wheel 840 and is driven thereby. Additionally, the shaft 270 is received in a guide block 850 that constrains the shaft to move in a linear motion. The guide block 850 includes a guide set 852 (e.g., finger rails) that extends therefrom, and the guide wheel 840 includes a groove 842 along an outer edge that is constrained by the guide set to encourage linear travel of the guide wheel 840. As the shaft 270 moves, the guide wheel 840 rolls and/or slides along the guide set 852 to aid in aligning the shaft 270.

The gear 810 is considerably smaller in diameter than the gear section 250 of the arm 114. Thus, for a given angular displacement of the gear section 250, the gear 810 may rotate one or more times, causing the shaft 270 to cycle up and down one or more times. Therefore, a single actuation of the arm 114 may cause the pistons in a cylinder to cycle several times. The number of times the pistons 230 may cycle for a given angular displacement of the gear 250 may be changed by altering the diameters of the first and second gears 250 and 810.

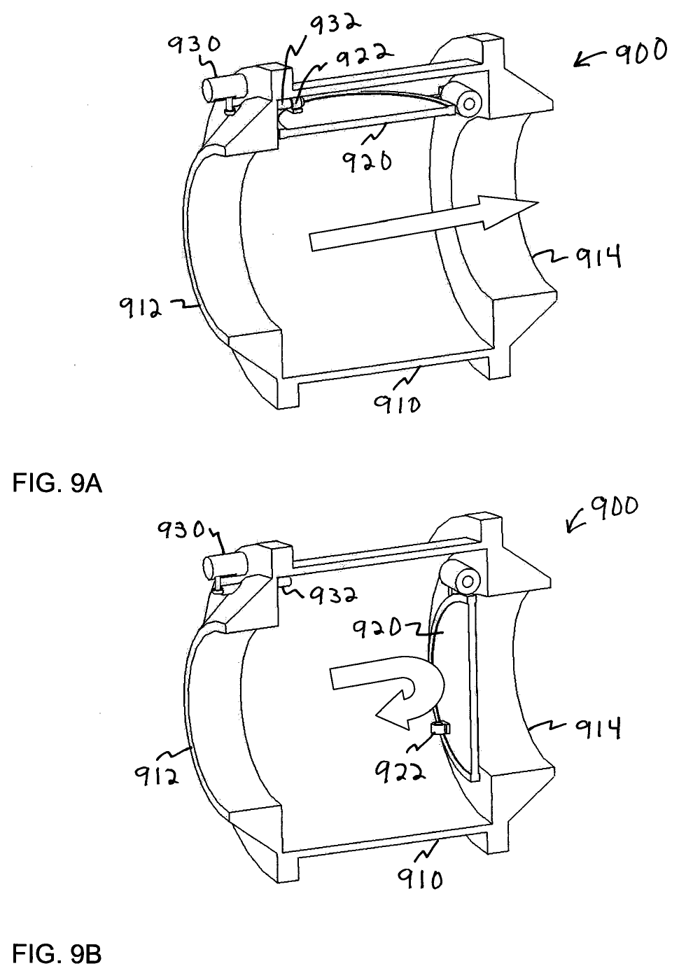

FIGS. 9A-B show an example valve 900 for use in a power generation system. Valve 900 may, for example, be used for shutting off fluid flow if a predetermined condition (e.g., contamination) is detected.

Valve 900 includes a body 910 having first and second openings 912 and 914 and a gate 920 pivotable within the body 910. The gate 920 includes an appendage 922 extending therefrom. Valve 900 also includes an actuator 930. The actuator 930 includes a detent 932 (e.g., a pin) sized to extend through an opening in the appendage 922. The actuator may be automatically or manually operated.

During normal operations, the gate 920 may be fixed in an open position to provide fluid communication between the first and second openings 912, 914. To seal the valve 900, the actuator 930 retracts the detent 932 from the appendage 922, and the gate 920 pivots into the flow path to close the valve. The gate 920 may be closed based on the detection or occurrence of a defined event or condition. For example, if a leak or some other condition or event is detected, the gate 920 may be released and pivot downwardly into a closed position, preventing pumping fluid from passing through the valve 900.

A number of physical implementations have been described and illustrated herein. The described and illustrated implementations, however, should not be viewed as detailed engineering specifications and drawings. They have been made primarily to illustrate the components of the implementations and how they interact in order that those skilled in the art can understand the construction and operations of various implementations. Thus, at different points, some components may have been resized (e.g., enlarged or shrunk), not shown, and/or rearranged slightly, in order to illustrate the components of particular interest at that point. Moreover, all components of the drawings are not necessarily to scale.

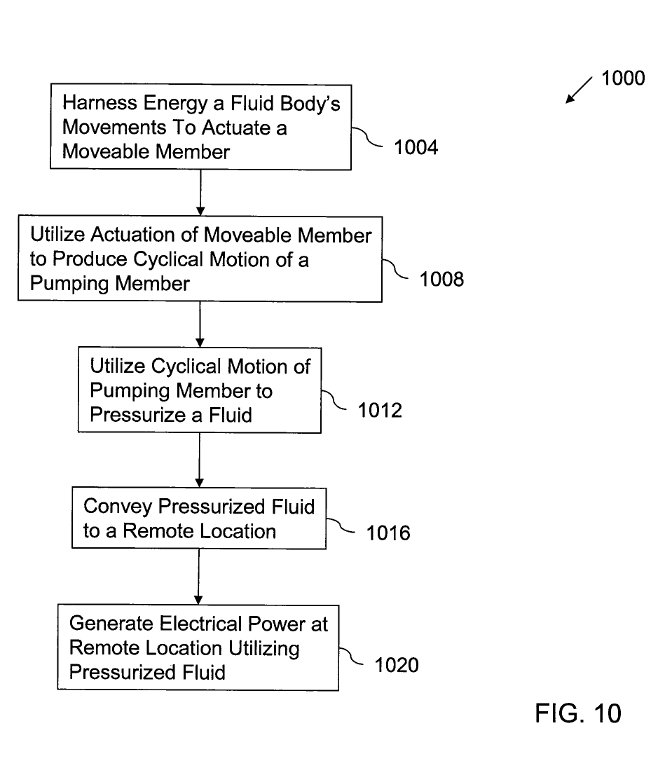

FIG. 10 illustrates an example process 1000 for generating electrical power via the movement of a fluid body. Process 1000 may, for example, illustrate a process by which one or more of the previously discussed implementations generates electrical power from fluid body movements.

Process 1000 calls for harnessing the energy of a fluid body's movements to actuate a moveable member (operation 1004). For example, the wave energy of a water body (e.g., an ocean) may be harnessed by placing a buoyant end of a rotatable arm in the water. The waves may cause the buoyant end to rise and fall, causing the arm to articulate. Process 1000 uses the actuation of the moveable member to produce a cyclical motion, such as a back-and-forth linear motion, of a pumping member (e.g., an elongated member) (operation 1008). The pumping member may, for example, be a shaft coupled to the moveable member through a power conversion mechanism. The cyclical motion of the pumping member is used to pressurize a fluid (operation 1012). For example, the pumping member may have one or more pistons coupled thereto, and each piston may be made to reciprocate within a chamber to pressurize a fluid. The pressurized fluid is conducted to a remote location (operation 1016). For example, the pressurized fluid may form a fluid flow that is conveyed through a system of conduits from a pumping station located in a water body to a power generation station located on the shore. At the remote location, the pressurized fluid is used to generate electrical power (operation 1020). For example, the pressurized fluid may be made to actuate a turbine that is coupled to an electrical power generator such that the generator generates electricity when actuated by the turbine.

Although FIG. 10 illustrates one process for generating electrical power via the movement of a fluid body, other processes for generating electrical power via the movement of a fluid body may include fewer, additional, and/or a different arrangement of operations. For example, a process may include conveying the fluid, possibly in a depressurized state, back to the pump. As another example, a number of moveable members may be disposed in the fluid body to actuate a number of pumping members. A number of pumping members may, for example, be located at the same pumping station. The pressurized fluid from the pumping members may be used individually or in combination to generate electricity. Additionally, two or more of a process's operations may be performed in a contemporaneous or simultaneous manner. In particular modes of operation, for example, most, if not all, of a process's operations may be occur at substantially the same time. Moreover, a processes operations may be performed continuously or intermittently for any period of time.

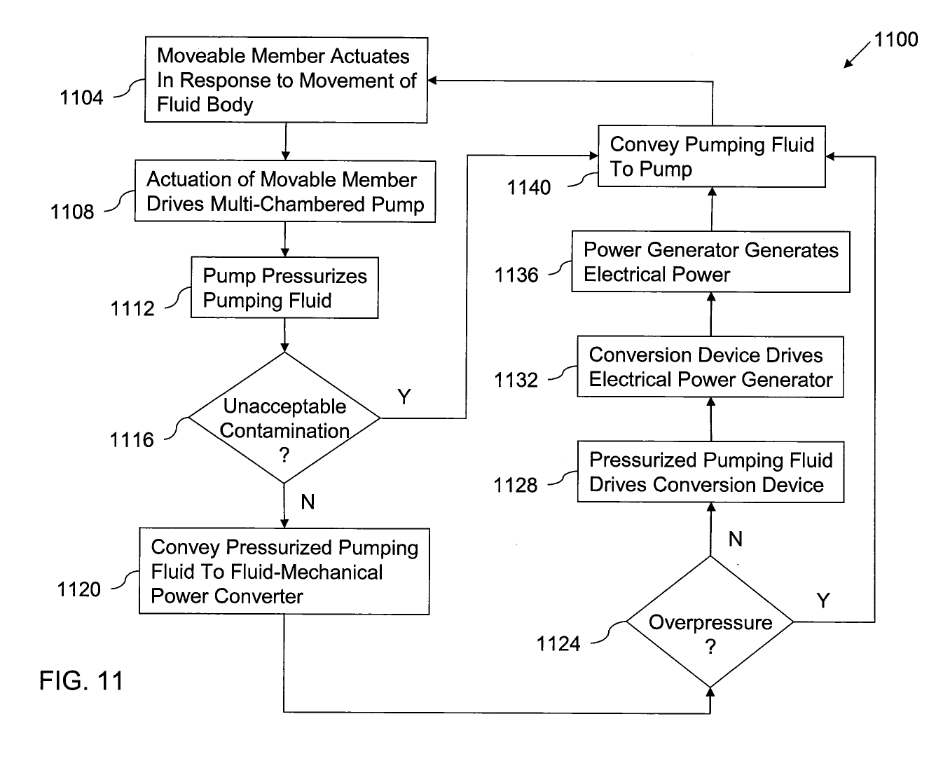

FIG. 11 illustrates another example process 1100 for generating electrical power via the movement of a fluid body. Process 1100 may, for example, illustrate a process by which one or more of the previously discussed implementations generates electrical power from fluid body movements.

Process 1100 calls for a moveable member actuating in response to movement of a fluid body (operation 1104). For example, the waves of a water body (e.g., a lake) may cause a buoyant end of a pivotable arm to rise and fall, causing the arm to articulate. The actuation of the moveable member drives a multi-chambered pump (operation 1108). The pump may, for example, include a number of chambers with a piston associated with each chamber. The moveable member and the pump may be coupled together through a power conversion mechanism, which may produce a cyclical motion for the pumping mechanism. The pump pressurizes a pumping fluid in response to being driven (operation 1112). For example, the fluid in each of a number of chambers may be pressurized and combined into a single fluid flow.

The pumping fluid may be analyzed to determine whether it is unacceptably contaminated (operation 1116). A sensor may, for example, determine whether too much particulate matter is present in the pumping fluid, which may degrade mechanical components. If the level of contamination is not unacceptable, the pumping fluid is conveyed to a fluid-mechanical power converter (operation 1120). The pressurized pumping fluid may, for example, form a fluid flow that is conveyed by a conduit system.

While the fluid is being conveyed to the conversion device, process 1100 calls for determining whether the pressure of the pumping fluid is too high (operation 1124). A sensor may, for example, determine whether the pressure of the pumping fluid is to high. If the pressure of the pumping fluid is not too high, the pumping fluid arrives at the conversion device and drives it (operation 1128). The conversion device may, for example, be a turbine, and the pumping fluid may flow around the turbine's vanes to drive the turbine.

The conversion device drives an electrical power generator (operation 1132). The conversion device may, for example, be coupled to the power generator through the use of a rotary shaft. The power generator generates electrical power in response to being driven by the conversion device (operation 1136).

The pumping fluid is conveyed back to the pump from the conversion device (operation 1140). The pumping fluid may, for example, be carried through a system of conduits to a pumping station. The pumping fluid may then again be pressurized by another movement of the fluid body.

If, however, an unacceptable level of contamination is detected in the pumping fluid (operation 1116), the pumping fluid may be conveyed back to the pump (operation 1140). Thus, contaminated pumping fluid may be prevented from reaching the conduit system, the conversion device, and/or other components of the power generation system.

Additionally, if too much pressure is detected in the pumping fluid (operation 1124), the pumping fluid may be conveyed back to the pump (operation 1140). Thus, over-pressurized pumping fluid may be prevented from reaching the conversion device and/or other components of the power generation system.

Although FIG. 11 illustrates one implementation of a process for generating electrical power via the movement of a fluid body, other implementations for generating electrical power via the movement of a fluid body may include fewer, additional, and/or a different arrangement of operations. For example, a process for generating electrical power via the movement of a fluid body may include a number of moveable members that are disposed in the fluid body to actuate a number of pumps, which may be part of a single pumping station or separate pumping stations. The pressurized fluid from the pumps may be used individually or in combination to generate electricity. As another example, a process may call for sensing the level of fluid in a reservoir and generating an alarm and/or shutting down the pumping station if the level is too low. Additionally, two or more of a process's operations may be performed in a contemporaneous or simultaneous manner. In particular modes of operation, for example, all of a processes operations may occur at the same time. For example, at substantially the same time, some of the pumping fluid may be being pressurized, some of the pumping fluid may be being conveyed to the conversion device, some of the pumping fluid may be driving the conversion device, and some of the pumping fluid may be being conveyed back to the pumping mechanism. Moreover, a process's operations may be performed continuously or intermittently for any period of time. As another example, checking for contamination and/or overpressure may not be performed.

A number of implementations have been described, and several others have been mentioned or suggested. Moreover, those skilled in the art will recognize that numerous additions, deletions, substitutions, and/or modifications may be made to the implementations while still achieving electrical power generating via movement of a fluid body. Thus, the scope of protected subject matter should be judged based on the following claims, which may encompass one or more aspects of one or more implementations.

1. A system for utilizing movements of a fluid body to pressurize a pumping fluid for generating electrical power, the system comprising:
a pumping station positioned offshore and comprising:
a housing comprising a reservoir containing a volume of pumping fluid; and
at least one pumping mechanism, each pumping mechanism comprising:
a moveable member extending at least partially from the housing and adapted to follow movements of the fluid body; and
a fluid pump coupled to the moveable member and adapted to pressurize a pumping fluid in response to motion of the moveable member, the fluid pump comprising:
a multi-chambered cylinder;
a shaft extending through the multi-chambered cylinder and driven by the moveable member; and
a plurality of pistons attached to the shaft, each piston disposed in a separate chamber of the multi-chambered cylinder, the plurality of pistons adapted to pressurize a pumping fluid in response to motion of the moveable member.

2. The system of claim 1, wherein the pumping station comprises a plurality of radially disposed pumping mechanisms.

3. The system of claim 1, wherein the moveable member is coupled to the shaft by a power conversion mechanism.

4. The system of claim 3, wherein the power conversion mechanism comprises:
a gear rotatably coupled to the moving member and driven thereby; and
a linkage operably disposed between the gear and the shaft of the fluid pump to drive the shaft.

5. The system of claim 4, wherein the linkage is a cam linkage.

6. The system of claim 4, wherein the power conversion mechanism is adapted to cause the pistons in the multi-chambered cylinder to cycle at least one time for a displacement of the moveable member of at least a defined distance in a first direction and to cycle at least one time for a displacement of the moveable member at least the defined distance in a second direction.

7. The system of claim 1, wherein the moveable member comprises:
an elongated member that extends from the housing; and
a buoyant member pivotably coupled to the elongated member proximate an end of the elongated member distal from the housing and adapted to follow movements of the fluid body.

8. The system of claim 1, wherein at least a portion of the pumping mechanism is at least partially submerged in the pumping fluid contained within the housing.

9. The system of claim 1, wherein a piston is adapted to allow the pumping fluid to pass from one side of the piston to the other.

10. The system of claim 9, wherein the piston is adapted to allow the pumping fluid to pass from one side of the piston to the other when the piston moves in a first direction but not allow the pumping fluid to pass from one side of the piston to the other when the piston moves in a second direction.

11. The system of claim 1, further comprising a power generation station coupled to the pumping station and driven by the pressurized pumping fluid to generate electrical power.

12. The system of claim 11, wherein the power generation station comprises:
a fluid-mechanical power converter positioned on a shore of the fluid body and coupled to a first conduit system that conveys the pressurized pumping fluid from the pumping station and a second conduit system that conveys the pumping fluid back to the pumping station; and
a power generator coupled to and driven by the power converter.

13. The system of claim 11, wherein the system comprises a plurality of pumping stations that drive the power generation station with pressurized pumping fluid.

14. A method for utilizing movements of a fluid body to pressurize a pumping fluid for generating electrical power, the method comprising:
actuating a moveable member extending from a housing located offshore in response to movements of a fluid body;
driving a shaft of a multi-chambered fluid pump in the housing based on actuation of the movable member; and
pressurizing pumping fluid from a reservoir in the housing with pistons located in the chambers of the fluid pump and coupled to the shaft.

15. The method of claim 14, further comprising:
conveying the pressurized pumping fluid to a remote location;
converting energy of the pressurized pumping fluid into mechanical power at the remote location;
generating electrical power with the mechanical power; and
conveying the pumping fluid back to the housing.

16. The method of claim 14, further comprising:
actuating a number of moveable members extending from the housing and radially disposed around the housing; and
pressurizing the pumping fluid from the reservoir with fluid pumps associated with the moveable members.

17. The method of claim 14, further comprising cycling the fluid pump at least one time for at least a predefined displacement of the moveable member in a first direction and cycling the fluid pump at least one time for at least the predefined displacement of the moveable member in a second direction.

18. The method of claim 14, wherein at least a portion of the moveable member and the shaft are submerged in the pumping fluid contained in the housing.

19. The method of claim 14, further comprising allowing the pumping fluid to pass from one side of the pistons to the other when the shaft moves in a first direction but not allow the pumping fluid to pass from one side of the piston to the other when the shaft in moves a second direction.

20. A system for utilizing movements of a fluid body to pressurize a pumping fluid for generating electrical power, the system comprising:
a pumping station disposed offshore, the pumping station comprising:
a housing;
a pumping fluid reservoir formed in the housing; and
a plurality of pumping mechanisms disposed in the housing, each pumping mechanism comprising:
a movable member extending from the housing and adapted to follow movements of the fluid body;
a fluid pump adapted to pressurize a pumping fluid in response to motion of the moveable member; and
a power conversion mechanism coupled between the moveable member and the fluid pump, the power conversion mechanism adapted to cause a cycle of the fluid pump when the moveable member moves a defined distance in a first direction and a cycle of the fluid pump when the moveable member moves the defined distance in a second direction.

21. The power generation system of claim 20, wherein the fluid pump comprises:
a cylinder;
a plurality of chambers formed within the cylinder;
a shaft coupled to the power conversion mechanism and extending through the plurality of chambers; and
a plurality of pistons coupled to the shaft, each piston disposed in a separate chamber.

22. The power generation system of claim 21, wherein each of the plurality of chambers includes a fluid inlet and a fluid outlet.

23. The power generation system of claim 22, wherein a one-way valve is disposed in each of the fluid inlets and fluid outlets.

24. The power generation system of claim 20, wherein the moveable member comprises a gear section and the power conversion mechanism comprises:
a gear meshed with the gear section and pivotable thereby;
a linkage comprising a first link and a second link, the first link fixedly coupled to the gear at a first end and pivotably coupled to the second link at a second end; and
a wheel axis pivotably coupled to the second link and the fluid pump to drive the fluid pump.

25. The power generation system of claim 24, wherein an outer diameter of the gear section is greater than an outer diameter of the gear.

26. The power generation system of claim 24, further comprising:
a wheel coupled to the wheel axis; and
a guide set for the wheel, the guide set encouraging linear action of the fluid pump.

27. The power generation system of claim 20, further comprising a power generation station coupled to the pumping station and driven by pressurized pumping fluid.

28. The power generation system of claim 27, further comprising:
a plurality of pumping stations; and
a conduit system comprising a fluid output conduit and a fluid return conduit in communication with each pumping station, the output conduits adapted to conduct a pressurized pumping fluid from the pumping stations to the power generation station, and the return conduits adapted to return the pumping fluid from the power generation station to the pumping stations.

29. The power generation system of claim 20, wherein the pumping fluid at least partially fills the reservoir and at least a portion of the pumping mechanisms is disposed within the reservoir and is at least partially immersed by the pumping fluid.
